(19) United States
(12) Patent Application Publication
(10) Pub. No.: US 2008/0158258 A1
(43) Pub. Date: Jul. 3, 2008

(54) Method and System For Obtaining a Digitally Enhanced Image

(75) Inventors: David B. Lazarus, Elkins Park, PA (US); John D. Ogden, Media, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/616,350

(22) Filed: Dec. 27, 2006

(51) Int. Cl. G06T 5/50

(52) U.S. Cl. 345/634; 382/254

(57) ABSTRACT

A method and system for obtaining a digitally enhanced image is provided. The method includes capturing a plurality of digital images. The plurality of digital images is captured on at least two different illumination levels from a controlled light source. Further, the method includes analyzing the plurality of digital images to obtain an image representing illumination contribution provided by a controlled light source. Furthermore, the method includes amplifying each pixel of the image representing the illumination contribution. Moreover, the method includes combining the image representing illumination contribution with at least one of the plurality of digital images, to produce a composite image.

### FIELD OF THE INVENTION

The present invention generally relates to the field of image processing and video processing, and more particularly, to a method and system for obtaining a digitally enhanced image.

### BACKGROUND OF THE INVENTION

Nowadays, image processing and video processing is widely used to enhance the quality of an image captured by a digital device. The digital device can be a digital camera, a video camera, a video-conferencing device, a digital telescope, and the like. The image captured by a digital device may have a dark subject and a bright background if the sources of the ambient light are located mostly behind the subject. Generally, this problem of the dark subject and the bright background is solved by the addition of light sources such as flash. Usually these light sources are controlled by the digital device.

While capturing an image of an object, ambient light sources can be present in the environment of the object. Often, the illumination provided by the ambient light sources is not neutral in color and causes a variation in the original color of the image of the object.

Some of the digital cameras available are provided with an electronic flash to avoid the dark subject and the bright background in a captured image. The electronic flash is activated when the foreground illumination is not sufficient, and eliminates the problem of dark subject and the bright background in the image. However, the electronic flash requires a strong power source and may generate heat, which might affect the working of the camera. Further, the large size and weight of the electronic flash increases the size and weight of the camera. Moreover, the illumination provided by the electronic flash may cause discomfort or annoyance to the subject. For example, people often blink when exposed to an electronic flash.

Accordingly, in light of the foregoing, there exists a need for developing alternative solutions to remove the problem of dark subject and the bright background from the image of an object without using a strong light source or increasing the size and weight of the system. Further, there exists a need for removing variations in the color of the images of the objects, caused by the illumination provided by the ambient light sources present in the environment of the object.

### BRIEF DESCRIPTION OF DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a mobile phone where the present invention can be used;

FIG. 2 illustrates a flow diagram depicting a method for obtaining a digitally enhanced image, in accordance with an embodiment of the present invention;

FIG. 3 and FIG. 4 illustrate a flow diagram depicting a method for obtaining a digitally enhanced image, in accordance with another embodiment of the present invention;

FIG. 5 and FIG. 6 illustrate a flow diagram depicting a method for obtaining digitally enhanced video, in accordance with an embodiment of the present invention;

FIG. 7 illustrates a block diagram of a system for obtaining a digitally enhanced image, in accordance with an embodiment of the present invention;

FIG. 8 illustrates a block diagram of a system for obtaining digitally enhanced video using a controlled light source, in accordance with another embodiment of the present invention; and

FIG. 9 illustrates a block diagram of a system for obtaining digitally enhanced video where the controlled light source comprises a video display, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular of the present invention, it should be observed that the present invention utilizes a combination of method steps and apparatus components related to the method and system for obtaining a digitally enhanced image. Accordingly, the apparatus components and method steps have been represented where appropriate by conventional symbols in the drawings, showing only those specific details that are pertinent for an understanding of the present invention, so as not to obscure the disclosure with details that will be readily apparent to those with ordinary skill in the art, having the benefit of the description herein. method and system for obtaining a digitally enhanced image, in accordance with various embodiments

In this document, the terms ‘comprises,’ ‘comprising,’ ‘includes,’ or any other variation thereof, are intended to cover a non-exclusive inclusion, such that a process, article, system or apparatus that comprises a list of elements does not include only those elements but may include other elements not expressly listed or inherent to such a process, article or apparatus. An element proceeded by ‘comprises . . . a’ does not, without more constraints, preclude the existence of additional identical elements in the process, article, system or apparatus that comprises the element. The terms “includes” and/or “having”, as used herein, are defined as comprising.

There are many different color representation schemes (e.g., RGB, HSV) used in digital and video photography. The present invention may be applied to any color representation scheme. For the purposes of this disclosure pixel values refer to a luminance of the pixels, unless the specific context of color is mentioned.

For the present invention the convention used for measuring light is a linear scale proportional to the number of photons per second for a given area. The present invention may also be used where the representational scheme is logarithmic, however, the mathematical operations should be made to match the particular representational scheme.

For one embodiment, a method for obtaining a digitally enhanced image is provided. The method includes capturing a plurality of digital images. The plurality of digital images is captured on at least two differing illumination levels from a controlled light source. Further, the method includes analyzing the captured plurality of the digital images, to identify the illumination contribution provided by the controlled light source. Furthermore, the method includes amplifying the identified illumination contribution. Moreover, the method includes combining the amplified illumination contribution with at least one of the plurality of captured images, to produce a composite digital image.

For another embodiment, a system for obtaining a digitally enhanced image is provided. The system includes a memory for storing a plurality of digital images. The plurality of digital images is captured on at least two differing illumination levels from a controlled light source. Further, the system includes a processor that analyzes the stored plurality of digital images, to identify the illumination contribution provided by the controlled light source, to amplify the identified illumination contribution and combine the amplified illumination contribution with at least one of the plurality of stored digital images, to form a composite digital image.

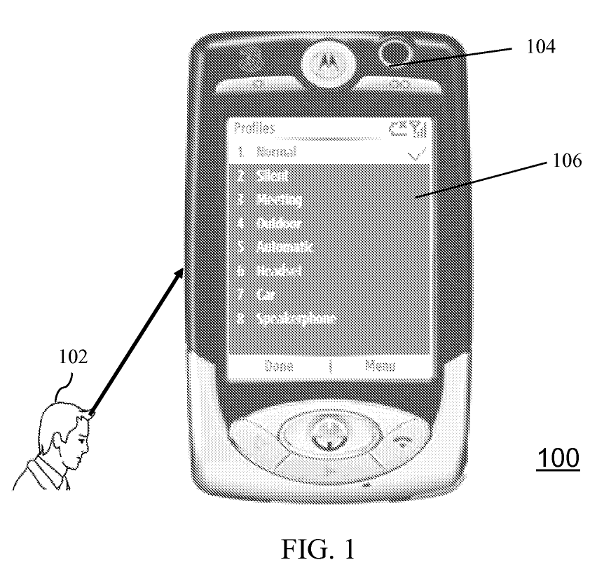

FIG. 1 illustrates a mobile phone 100 where the present invention can be used. The mobile phone 100 can be present in a communication network. The mobile phone 100 may be utilized by user 102 to capture still images and video. The user 102 may also transmit an image, a collection of images, or video captured by the digital camera 104 to other devices present in the communication network that are capable of receiving the information. The mobile phone 100 includes a digital camera 104. The digital camera 104 can be used for capturing still images of an object. The digital camera 104 can also be used for making a video of an object. The mobile phone 100 further may include either a liquid crystal display 106, conventional light source 108 (e.g. bulb, LED), or both. The light sources 106, 108 can be used as a light source for providing illumination to the object while capturing images of the object from the digital camera 104.

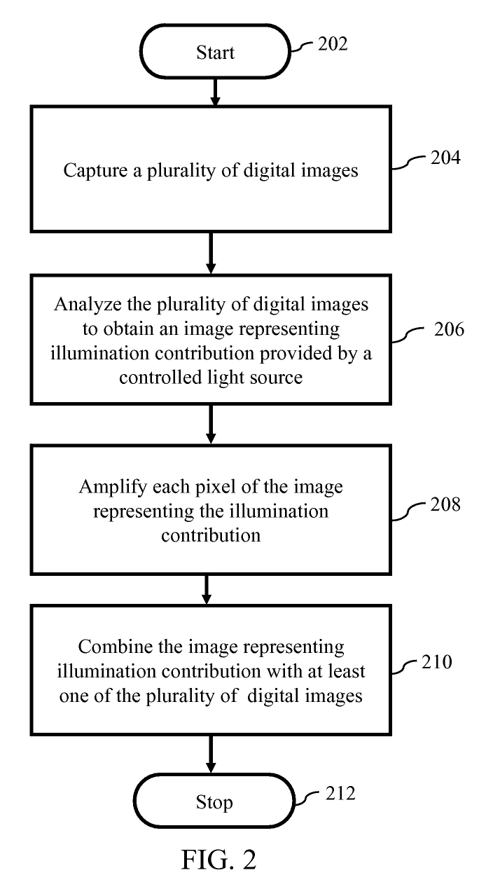

FIG. 2 is a flow diagram illustrating a method for obtaining a digitally enhanced image, in accordance with an embodiment of the present invention. At step 202, the method is initiated. At step 204, a plurality of digital images of an object is captured. In an embodiment, the plurality of digital images includes a sequence of digital pictures. In another embodiment, the plurality of digital images includes a sequence of video images. The plurality of digital images is captured on at least two different illumination levels from a controlled light source. An illumination level determines the amount of illumination emitted by the controlled light source. A higher illumination-level controlled light source emits more light, as compared to a lower illumination-level controlled light source. The controlled light source can be a liquid crystal display, a cathode ray tube, a plasma display, a digital light processor and the like.

At step 206, the plurality of digital images is analyzed to obtain an image representing illumination contribution provided by the controlled light source. In one embodiment, the image representing the illumination contribution is identified by comparing the plurality of digital images, captured at different illumination levels, with each other.

At step 208, each pixel of the image representing the illumination contribution of the controlled light source is amplified, since the controlled light source, used for illumination of the plurality of digital images, is a weak light source. In an embodiment, amplification of the image representing the illumination contribution is performed by multiplying each pixel of the image representing the illumination contribution by a scaling factor. For example, the value of the scaling factor may be four.

At step 210, the image representing the illumination contribution is digitally combined with at least one of the plurality of digital images, to obtain at least one composite digital image. In an embodiment, the step 210, of combining the image representing the illumination contribution with the at least one of the plurality of digital images includes aligning the image representing the illumination contribution with the at least one of the plurality of digital images. In this embodiment, the step 210, further includes adding the image representing the illumination contribution and the at least one of the plurality of digital images, pixel by pixel, to obtain the at least one composite digital image. The pixel value of a composite digital image of the at least one composite digital image is calculated by using the following equation:

pixel value=pixel value of the at least one of the plurality of digital images+pixel value of the image representing the amplified illumination contribution (1)

In an embodiment, where the color of the controlled light source is not neutral, e.g., an LCD display, and may change with time, the color of the image representing the illumination contribution is adjusted prior to combining the image representing the illumination contribution with the at least one of the plurality of digital images. In one embodiment, adjustment to the color of the image representing illumination contribution is done by computing the color of the controlled light source. The color of the controlled light source is computed by determining an average color of the display. In one embodiment, average color is determined by computing a mean pixel value for each primary color. In an embodiment, the color of the controlled light source changes with time, the mean pixel value for each primary color also changes with time. In this embodiment, the color correction of each pixel of the image representing the illumination contribution is based on mean pixel color of the controlled light source at the time of the image capture. Thereafter, the color of the image representing the illumination contribution is adjusted accordingly.

In an embodiment, the color of ambient light sources is adjusted in the at least one of the plurality of digital images prior to combining the image representing the illumination contribution with the at least one of the plurality of digital images. The ambient light sources are light sources present in the environment of the object other than the controlled light source. In this embodiment, pixels in the at least one of the plurality of captured digital images that are illuminated by both the ambient light sources and the controlled light source are identified. Further, in this embodiment, true color of the pixels is determined from their color values in the illumination contribution of the controlled light source. If the controlled light source is non-neutral in color or varies in output over time, then the color of the pixels is corrected based on color output of the controlled light source at the time of the image capture. Furthermore, in this embodiment the color of the ambient light sources are determined by comparing the true color of the pixels in the at least one of the plurality of digital images with the pixels in the at least one of the plurality of digital images that are illuminated only by the ambient light sources. Furthermore, the color of the ambient light sources is adjusted from the at least one of the plurality of digital images. At step 212, the method is terminated.

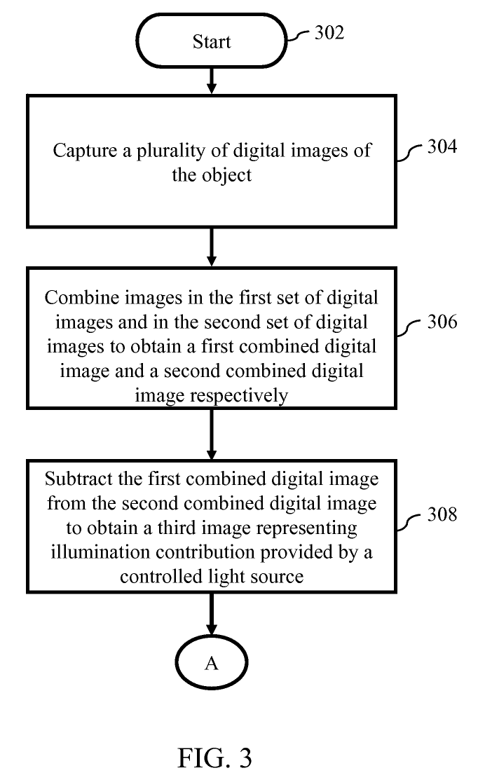

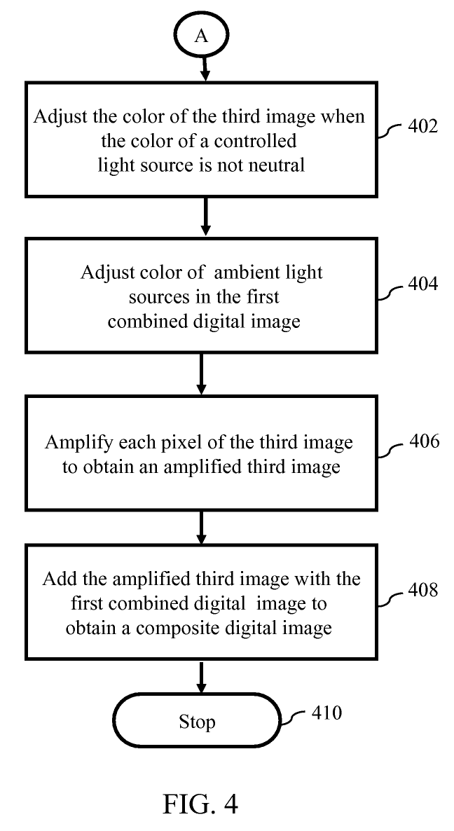

FIG. 3 and FIG. 4 illustrate a flow diagram depicting a method for obtaining a digitally enhanced image, in accordance with another embodiment of the present invention. At step 302, the method is initiated. At step 304, a plurality of digital images is captured. The plurality of digital images includes a first set of digital images and a second set of digital images. The first set of digital images is captured by using a controlled light source and the second set of digital images without using any controlled light source. For example, the first set of digital images is captured by using a camera phone with a weak flash and the second set of digital images is captured by using the camera phone without the flash.

At step 306, the images in the first set of digital images are digitally combined to obtain a first combined digital image, and the images in the second set of digital images are digitally combined to obtain a second combined digital image. In an embodiment, prior to digitally combining images in the first set of digital images, they are aligned to minimize the effect of motion. In this embodiment, digitally combining images in the first set of digital images further involves digitally adding the images present in the first set of digital images, pixel by pixel, to obtain a first intermediate digital image. Further, in this particular embodiment, each pixel of the first intermediate digital image is digitally averaged, to obtain the first combined digital image. In an embodiment, digitally combining images in the second set of digital images involves aligning all the images in the second set of digital images. In this embodiment, digitally combining images in the second set of digital images further involves adding the images present in the second set of digital images, pixel by pixel, to obtain a second intermediate digital image. Further, in this particular embodiment, each pixel of the second intermediate digital image is digitally averaged, to obtain the second combined digital image.

At step 308, the second combined digital image is subtracted from the first combined digital image to obtain a third image. The third image represents illumination contribution provided by the controlled light source. At step 402, the color of the third image is adjusted when the color of the controlled light source is not neutral. Each pixel value of the third image is calculated by using the following equation:

Pixel value=Pixel value of the first combined digital image−Pixel value of the second combined digital image (2)

At step 404, the color of the ambient light sources in the second combined digital image is adjusted. The ambient light sources are light sources present in the environment of the object other than the controlled light source. The second combined digital image is compared with the third combined digital image. Pixels from both the second and third combined images are selected based on illumination level. The color of the third combined digital image is used as a reference to correct the color of the second combined digital image. In one embodiment, pixels having high illumination levels may be used to correct the color component.

If the controlled light source is non-neutral in color or varies in output, then the color of the pixels in the third combined digital image is corrected based on color output of the controlled light source at the time of the image capture before the second combined digital image is adjusted.

At step 406, each pixel in the third image is amplified to obtain an amplified third image. In an embodiment, amplification of the third image is performed by multiplying each pixel in the third image by a scaling factor to obtain an amplified third image. For example, the value of the scaling factor may be four. Each pixel value of the amplified third image is calculated using the following equation:

Pixel value of the amplified third image=Pixel value of the third image*Scaling factor (3)

At step 408, the amplified third image is added to the first combined digital image to obtain a composite digital image. At step 410, the method is terminated. Each pixel value of the composite digital image is calculated using the following equation:

Pixel value of the composite digital image=Pixel value in the first combined digital image+Pixel value of the amplified third image. (4)

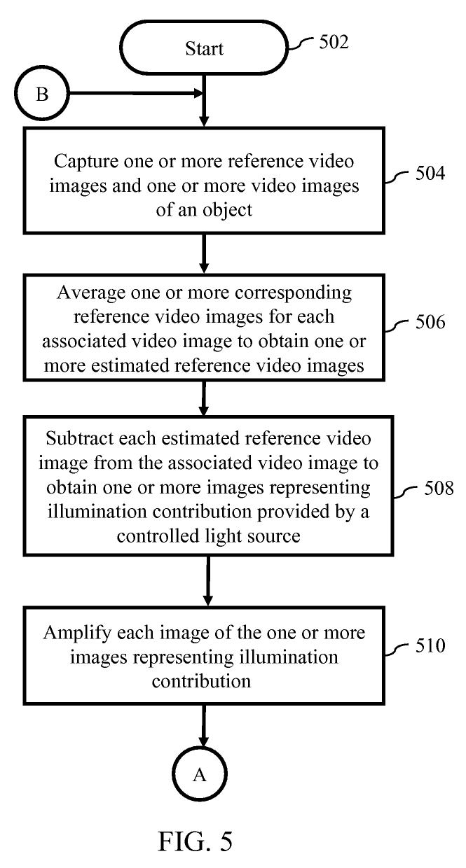

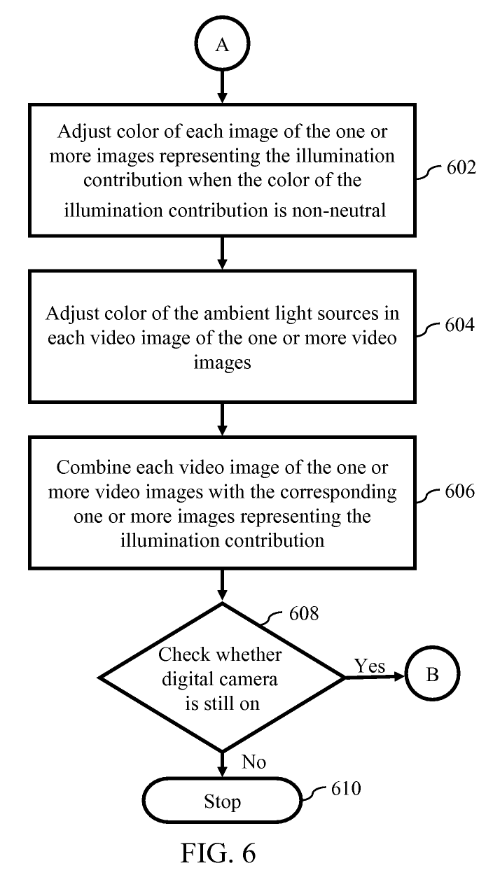

FIG. 5 and FIG. 6 illustrate a flow diagram depicting a method for obtaining digitally enhanced video in accordance with an embodiment of the present invention. At step 502, the method is initiated. At step 504, one or more video images comprising controlled illumination video images and ambient illumination video images are captured.

At step 506, a controlled illumination video image is selected or estimated for the output frame. At step 507, an ambient illumination video image is selected or estimated for the current frame. At step 508, each ambient video image is subtracted from its associated controlled illumination video image to obtain an image represented an illumination contribution provided by a controlled light source. The pixel value for an image of the one or more images representing the illumination contribution is calculated using the following equation:

Pixel value=Pixel value in the associated video image−Pixel value in the estimated reference video image (5)

At step 510, the illumination contribution video image is amplified, since the at least one light source, used for illumination, is a weak light source. In one embodiment, the amplification of an image of the one or more images representing the illumination contribution is performed by multiplying each pixel of the image by a scaling factor.

At step 602, the color of the illumination contribution video image is adjusted when the color of the controlled light source is not neutral. At step 604, the color of ambient light is estimated by comparing pixels in both the illumination contribution video image and the ambient illumination video image. The ambient illumination video image is color corrected using the estimate. The ambient light sources are light sources present in the environment of the object other than the controlled light source. In one embodiment, step 604, includes identifying pixels in a video image of the one or more video images that are illuminated by the ambient light sources and the controlled light source.

At step 606, the color corrected illumination contribution video image and the color corrected ambient illumination video image are combined to produce an output video frame. The pixel value of a digitally enhanced image is calculated using the following equation:

Pixel value=Pixel value of the video image+(Pixel value of the corresponding image representing the amplified illumination contribution) (6)

At step 608, status of digital camera is checked. If the digital camera is still on then the method proceeds to step 609. At step 609 a new output video frame is started and the method proceeds to step 506. At step 610, the method is terminated.

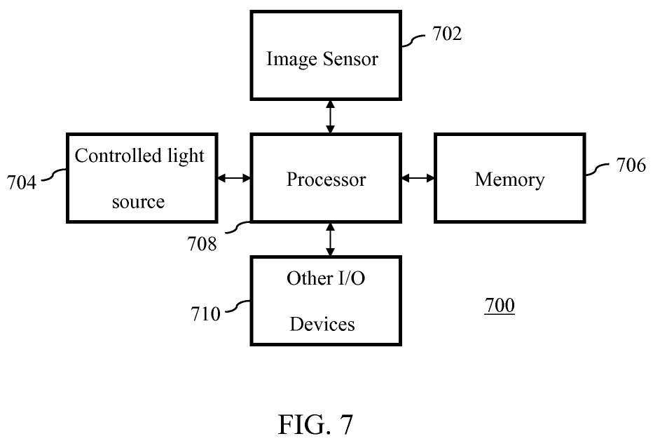

FIG. 7 illustrates a block diagram of a system 700 for obtaining digitally enhanced digital or video images, in accordance with one embodiment of the present invention. System 700 includes an image sensor 702, a controlled light source 704, a memory 706, a processor 708, and other I/O devices 710. Examples of the input/output device 710 includes, but are not limited to, a speaker, a display, a keyboard, a keypad, a mouse, a network interface, and a microphone. Image sensor 702 is adapted to capture a plurality of digital or video images. Controlled light source 704 is adapted to provide different illumination levels while capturing the plurality of digital or video images of the object. Memory 706 is adapted to store the plurality of digital images. The plurality of digital or video images is captured on at least two different illumination levels from controlled light source 704. Examples of memory 706 includes, but are not limited to, a random access memory (RAM), a read only memory (ROM), a hard disk drive and a floppy drive. The processor 708 is adapted to analyze the plurality of digital images, to obtain images representing illumination contribution provided by the controlled light source 704. Processor 708 is adapted to amplify each pixel of the image representing the illumination contribution and combine the image representing the illumination contribution with at least one of the plurality of stored digital or video images, to form at least one composite digital or video image. In one embodiment, processor 708 is further adapted to adjust the color of controlled light source 704 from the image representing the illumination contribution when the color of controlled light source 704 is not neutral.

In one embodiment, processor 708 is further adapted to adjust the color of ambient light sources in the plurality of digital or video images. The ambient light sources are light sources present in the environment of the object other than controlled light source 704. In this embodiment, pixels in at least one of the plurality of digital or video images that are illuminated by the ambient light sources and the controlled light source 704 are identified. Further, in this embodiment, true color of those pixels in the at least one of the plurality of digital or video images is determined from the color values of the illumination contribution of the controlled light source 704. If controlled light source 704 is non-neutral in color or varies in output, then the color of the pixels is corrected based on color output of the controlled light source 704 at the time of the image capture. Furthermore, in this embodiment the color of the ambient light sources are determined by comparing the true color of the pixels in the digital or video image(s) with the pixels in the digital or video image(s) that are illuminated only by the ambient light sources. Furthermore, the color of the ambient light sources is adjusted in the digital or video image(s).

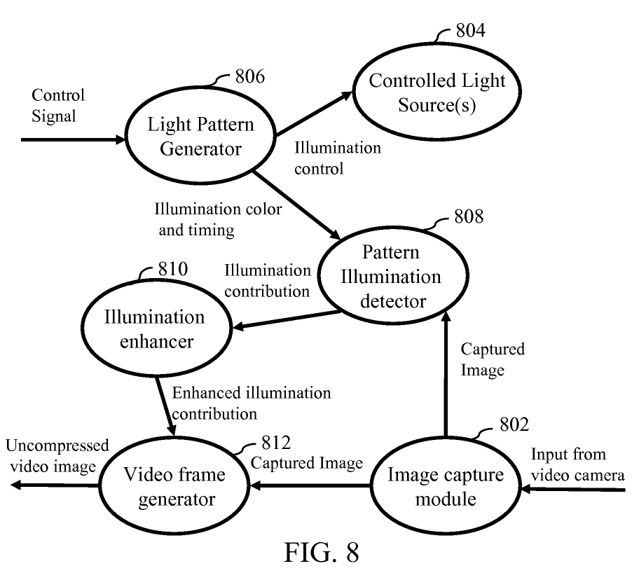

FIG. 8 illustrates a block diagram of a system for obtaining digitally enhanced video, in accordance with an embodiment of the present invention. The system includes an image capture module 802, Controlled Light Source(s) 804, a light pattern generator 806, a pattern illumination detector 808, an illumination enhancer 810, and a video frame generator 812.

The image capture module 802 can capture a plurality of video images of an object. The controlled light source(s) 804 are used for illuminating the object while capturing the plurality of video images at different illumination levels. These light sources are any devices that can generate light output vary with time. Typically, this would be a white light with a predictable invisible flicker, where that flicker is controlled by the light pattern generator. It could include the backlight of a LCD display or a simple light. The light pattern generator 806 is operatively coupled to the controlled light source(s) 804. The light pattern generator 806 sends illumination control signals to the controlled light source 804. In one embodiment, the light pattern generator 806 hides the changes in illumination when the illumination level changes. In this embodiment, the light pattern generator 806 turns off the illumination for a very short period to hide the changes in the illumination level. The controlled light source(s) 804 use the illumination control signals to control the amount and/or color of light output by the controlled light source(s) 804 to illuminate the object while capturing the plurality of video images. In still another embodiment, the light pattern generator X06 is not necessary, because the controlled light source(s) X04 generates an intrinsic pattern that can be detected by the pattern illumination detector x08 by design.

The pattern illumination detector 808 is operatively coupled to the image capture module 802 and the light pattern generator 806. The pattern illumination detector 808 can receive the plurality of video images from the image capture module 802. The pattern illumination detector 808 correlates the plurality of recent video images to obtain an image representing the illumination contribution provided by the controlled light source(s) 804. The pattern illumination detector 808 can receive the information regarding the brightness and/or color of a controlled light source from the light pattern generator 806. The pattern illumination detector 808 can adjust the color of the image representing the illumination contribution when the color of the controlled light source is not neutral.

The illumination enhancer 810 is operatively coupled to the pattern illumination detector 808. The illumination enhancer 810 receives the image representing the illumination contribution from the pattern illumination detector 808. The illumination enhancer 810 amplifies each pixel of the image representing the illumination contribution provided by the controlled light source(s) 804. The video frame generator 812 is operatively coupled to the image capture module 802 and the illumination enhancer 810. The video frame generator 812 receives the plurality of video images from the image capture module 802. The video frame generator 812 receives the enhanced image representing the illumination contribution from the illumination enhancer 810. The video frame generator 812 adjusts the color of the ambient light sources in the plurality of video images. The ambient light sources are light sources present in the environment of the object other than the controlled light source(s) 804. The video frame generator 812 also combines the enhanced image representing the illumination contribution with each of the plurality of video images to obtain a plurality of enhanced video images.

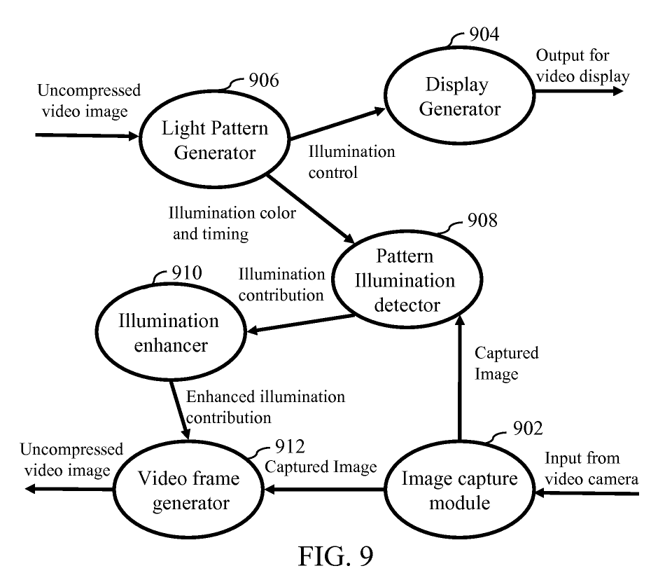

FIG. 9 illustrates a block diagram of a system for obtaining digitally enhanced video, in accordance with an embodiment of the present invention. The system includes an image capture module 902, a display generator 904, a light pattern generator 906, a pattern illumination detector 908, an illumination enhancer 910, and a video frame generator 912.

The image capture module 902 can capture a plurality of video images of an object. The display generator 904 is a controlled light source used for illuminating the object while capturing the plurality of video images at different illumination levels. The light pattern generator 906 is operatively coupled to the display generator 904. The light pattern generator 906 sends illumination control signals to the display generator 904. In one embodiment, the light pattern generator 906 hides the changes in illumination when the illumination level changes. In this embodiment, the light pattern generator 906 turns off the illumination for a very short period to hide the changes in the illumination level. The display generator 904 uses the illumination control signals to control the amount of light output by the display generator 904 to illuminate the object while capturing the plurality of video images.

The pattern illumination detector 908 is operatively coupled to the image capture module 902 and the light pattern generator 906. The pattern illumination detector 908 can receive the plurality of video images from the image capture module 902. The pattern illumination detector 908 correlates the plurality of recent video images to obtain an image representing the illumination contribution provided by the display generator 904. The pattern illumination detector 908 can receive the information regarding the color of a controlled light source from the light pattern generator 906. The pattern illumination detector 908 can adjust the color of the image representing the illumination contribution when the color of the controlled light source is not neutral.

The illumination enhancer 910 is operatively coupled to the pattern illumination detector 908. The illumination enhancer 910 receives the image representing the illumination contribution from the pattern illumination detector 908. The illumination enhancer 910 amplifies each pixel of the image representing the illumination contribution provided by the display generator 904. The video frame generator 912 is operatively coupled to the image capture module 902 and the illumination enhancer 910. The video frame generator 912 receives the plurality of video images from the image capture module 902. The video frame generator 912 receives the enhanced image representing the illumination contribution from the illumination enhancer 910. The video frame generator 912 adjusts the color of the ambient light sources in the plurality of video images. The ambient light sources are light sources present in the environment of the object other than the display generator 904. The video frame generator 912 also combines the enhanced image representing the illumination contribution with each of the plurality of video images to obtain a plurality of enhanced video images.

Various embodiments, as described above, provide a method and system for obtaining a digitally enhanced image of an object. In an embodiment, the digitally enhanced image includes sequence of video images. The present invention digitally eliminates darkness from an image of an object that is captured by using a weak light source. Since the light source used to capture an image is weak, the power requirement of the system is less, and the heat generated by the system is low, as compared to when an electronic flash is used to capture an image.

According to an embodiment, the present invention also balances the color of the image by estimating the color of the light sources used for the illumination and present in the environment of the object, and adjusting the colors accordingly.

The present invention can also work with a wide variety of digital devices, including a camcorder, by adding a weak light source that is neutral in color. The present invention is useful when used with a cell phone camera, where a power flash would require too much space and power.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims as issued.

What is claimed is:

1. A method for obtaining a digitally enhanced image, the method comprising:
capturing a plurality of digital images;
analyzing the plurality of digital images to obtain an image representing illumination contribution provided by a controlled light source;
amplifying each pixel of the image representing the illumination contribution; and
combining the image representing illumination contribution with at least one of the plurality of digital images.

2. The method as recited in claim 1, wherein the plurality of captured images comprise a sequence of video images.

3. The method as recited in claim 1, wherein the controlled light source comprises at least one of a liquid crystal display, a cathode ray tube and a plasma display, light bulb, digital light processor, LED.

4. The method as recited in claim 1, wherein combining the amplified illumination contribution with at least one of the plurality of captured digital images comprises a prior step of adjusting the color of the amplified illumination contribution so as to balance the color of the composite digital image when the color of the illumination contribution is not white.

5. The method as recited in claim 4 further comprises adjusting color of ambient light sources in the at least one of the plurality of captured digital images using the color of the amplified illumination contribution, wherein the ambient light sources are the light sources present in the environment.

6. The method as recited in claim 4 further comprises computing the color of the amplified illumination contribution when the color of the controlled light source changes with time.

7. A system for obtaining a digitally enhanced image, the system comprising:
an image sensor adapted for capturing plurality of digital images;
a controlled light source coordinated with to the image sensor, wherein the controlled light source is adapted to provide at least two differing illumination levels while capturing the plurality of digital images;
a memory adapted for storing the plurality of digital images, wherein the plurality of digital images comprises at least two differing illumination levels from the controlled light source; and
a processor adapted to analyze the stored plurality of digital images to analyze the plurality of digital images to obtain an image representing illumination contribution provided by a controlled light source, amplify each pixel of the image representing the illumination contribution, and combine the image representing illumination contribution with at least one of the plurality of digital images.

8. The system of claim 7, wherein the stored plurality of digital images comprise a sequence of video images.

9. The system of claim 7, wherein the controlled light source comprises at least one of a liquid crystal display, a cathode ray tube and a plasma display, light bulb, digital light processor, LED.

10. The system of claim 7, wherein the processor is further adapted to adjust the color of the amplified illumination contribution so as to balance the color of the composite digital image when the color of the illumination contribution is not neutral.

11. The system of claim 7, wherein the processor is further adapted to adjust the color of the ambient light sources in at least one of the plurality of captured digital images using the color of the amplified illumination contribution, wherein the ambient light sources are the light sources present in the environment.

12. The system of claim 7, wherein the processor is further adapted to compute the color of the amplified illumination contribution when the color of the controlled light source changes with time.

13. A method for obtaining a digitally enhanced image comprising:
capturing a plurality of digital images;
combining images in a first set of digital images and in a second set of digital images to obtain a first combined digital image and a second combined digital image;
subtracting the first combined digital image from the second combined digital image to obtain a third image representing illumination contribution provided by a controlled light source;
adjusting a color of the third image when a color of the controlled light source is not neutral;
adjusting a color of ambient light sources in the first combined digital image;
amplifying each pixel of the third image to obtain an amplified third image; and
adding the amplified third image with the first combined digital image to obtain a composite digital image.

14. A method for obtaining digitally enhanced video comprising:
capturing one or more video images comprising controlled illumination video images and ambient illumination video images;
selecting or estimating a controlled illumination video image for a current frame;
selecting or estimating an ambient illumination video image for the current frame;
subtracting the ambient illumination video image from the controlled illumination video image to obtain an image representing an illumination contribution provided by a controlled light source;
amplifying the illumination contribution video image;
adjusting a color of the illumination contribution video image when a color of the controlled illumination is non-neutral;
estimating a color of ambient light by comparing pixels in both the illumination contribution video image and the ambient illumination video image;
color correcting the ambient illumination video image using the estimate;
combining the color corrected illumination contribution video image and the color corrected ambient illumination video image to produce an output video frame.
